(19) United States
(12) Patent Application Publication
(10) Pub. No.: US 2006/0262188 A1
(43) Pub. Date: Nov. 23, 2006

(54) System and method for detecting changes in an environment

(76) Inventors: Oded Elyada, Tel-Aviv (IL); Ariel Almos, Tel-Aviv (IL); Avi Segal, Modiln (IL)

Correspondence Address: Martin Moynihan;c/o Anthony Castorina, Suite 207, 2001 Jefferson Davis Highway, Arlington, VA, 22202, US

(21) Appl. No.: 11/133,238

(22) Filed: May 20, 2005

(51) Int. Cl. H04N 9/47; H04N 5/225; H04N 7/18

(52) U.S. Cl. 348/143; 348/207.1

(57) ABSTRACT

A system capable of detecting changes within an environment in which a known image is displayed. The system includes a computing platform executing a software application being configured for comparing at least a portion of an image captured from the environment to at least a portion of the known image to thereby detect changes in the environment.

### FIELD AND BACKGROUND OF THE INVENTION

The present invention relates to a system and method for detecting changes in an environment and more particularly, to a system capable of translating image information captured from the environment into input data.

Image processing is used in many areas of analysis, and is applicable to numerous fields including robotics, control engineering and safety systems for monitoring and inspection, medicine, education, commerce and entertainment. It is now postulated that emergence of computer vision on the PC in conjunction with novel projected display formats will change the way people interact with electronic devices.

Detecting the position and movement of an object such as a human is referred to as “motion capture.” With motion capture techniques, mathematical descriptions of an objects movements are input to a computer or other processing system. For example, natural body movements can be captured and tracked in order to study athletic movement, capture data for later playback or simulation, to enhance analysis for medical purposes, etc.

Although motion capture provides benefits and advantages, simple visible-light image capture is not accurate enough to provide well-defined and precise motion capture and as such presently employed motion capture techniques utilize high-visibility tags, radio-frequency or other types of emitters, multiple sensors and detectors or employ blue-screens, extensive post-processing, etc.

Some motion capture applications allow a tracked user to interact with images that are created and displayed by a computer system. For example, an actor may stand in front of a large video screen projection of several objects. The actor can move, or otherwise generate, modify, and manipulate, the objects by using body movements. Different effects based on an actor's movements can be computed by the processing system and displayed on the display screen. For example, the computer system can track the path of the actor in front of the display screen and render an approximation, or artistic interpretation, of the path onto the display screen. The images with which the actor interacts can be displayed on the floor, wall or other surface; suspended three-dimensionally in space, displayed on one or more monitors, projection screens or other devices. Any type of display device or technology can be used to present images with which a user can interact or control.

Although several such interactive systems have been described in the art (see, for example, U.S. patent application Ser. Nos. 08/829,107; 09/909,857; 09/816,158; 10/207,677; and U.S. Pat. Nos. 5,534,917; 6,431,711; 6,554,431 and 6,766,036), such systems are incapable of accurately translating presence or motion of an untagged object into input data. This limitation of the above referenced prior art systems arises from their inability to efficiently separate an object from its background; this is especially true in cases where the background includes a displayed image.

In order to traverse this limitation, Reactrix Inc. has devised an interactive system which relies upon infra-red grid tracking of individuals (U.S. patent application Ser. No. 10/737,730). Detection of objects using such a system depends on differentiating between surface contours present in foreground and background image information and as such can be limited when one wishes to detect body portions or non-human objects. In addition, the fact that such a system relies upon a projected infrared grid for surface contour detection substantially complicates deployment and use thereof.

Thus, the prior art fails to provide an object tracking system which can be used to efficiently and accurately track untagged objects within an environment without the need for specialized equipment.

While reducing the present invention to practice, the present inventors have uncovered that in an environment having a displayed image it is possible to accurately and efficiently track an object by comparing an image captured from the environment to the image displayed therein. As is detailed herein such a system finds use in fields where object tracking is required including the field of interactive advertising.

### SUMMARY OF THE INVENTION

According to one aspect of the present invention there is provided an interactive system for translating a change to an environment into input data, the system comprising: (a) an image display device configured for displaying an image within the environment; (b) an image capture device configured for capturing image information from the environment; and (c) a computing platform executing a software application being configured for: (i) comparing at least a portion of the image as displayed by the image display device and the at least a portion of the image as captured by the image capture device to thereby determine the change to the environment; and (ii) translating the change into input data.

According to another aspect of the present invention there is provided a system capable of detecting changes within an environment in which a known image is displayed, the system comprising a computing platform executing a software application being configured for comparing at least a portion of an image captured from the environment to the at least a portion of the known image to thereby detect changes in the environment.

According to further features in preferred embodiments of the invention described below, the change within the environment is caused by introduction of an object into the environment.

According to still further features in the described preferred embodiments the image displayed by the image display device is a static image.

According to still further features in the described preferred embodiments the image displayed by the image display device is a dynamic image.

According to still further features in the described preferred embodiments the computing platform stores information regarding the image displayed by the image display device.

According to still further features in the described preferred embodiments step (i) above is effected by comparing pixel color value.

According to still further features in the described preferred embodiments the computing platform is capable of predicting the pixel color value of the image captured by the image capture device according to the environment.

According to still further features in the described preferred embodiments the image displayed by the image display device is a static or a dynamic image.

According to still further features in the described preferred embodiments the image displayed by the image display device is displayed by projection onto a surface present in the environment.

According to still further features in the described preferred embodiments the image displayed by the image display device is displayed by a monitor present within the environment.

According to still further features in the described preferred embodiments the computing platform stores information regarding the image displayed by the image display device.

According to still further features in the described preferred embodiments step (i) above is effected by a silhouetting algorithm.

According to still further features in the described preferred embodiments step (i) above discounts shadowing caused by the object.

According to yet another aspect of the present invention there is provided method of translating a change to an environment having an image displayed therein into input data, the method comprising: (a) capturing an image of the image displayed within the environment to thereby generate a captured image; and (b) computationally comparing at least a portion of the captured image to the at least a portion of the image displayed to thereby determine the change to the environment; and (c) translating the change into input data.

According to still further features in the described preferred embodiments the method further comprises computationally correcting the captured image according to at least one physical parameter characterizing the environment prior to step (b).

According to still further features in the described preferred embodiments the at least one physical parameter is lighting conditions.

According to still further features in the described preferred embodiments step (b) is effected by comparing a color value of pixels of the at least a portion of the captured image to the color value of the pixels of the at least a portion of the image displayed.

According to still further features in the described preferred embodiments step (b) is further for characterizing a shape and optionally movement of the object within the environment.

According to still further features in the described preferred embodiments step (b) is effected by a silhouetting algorithm.

According to still further features in the described preferred embodiments step (b) discounts shadowing caused by the object.

The present invention successfully addresses the shortcomings of the presently known configurations by providing a method for extracting silhouette information from a dynamically changing background and using such silhouette information to track an object in an environment.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is illustrates an interactive floor-projection configuration of the system of the present invention;

FIG. 2 is a flow chart diagram outlining system calibration in accordance with the teachings of the present invention;

FIG. 3 is a flow chart diagram of outlining background image generation in accordance with the teachings of the present invention;

FIG. 4 is a flow chart diagram outlining shadow artifact subtraction in accordance with the teachings of the present invention; and

FIG. 5 is a flow chart diagram outlining CST updating in accordance with the teachings of the present invention.

### DESCRIPTION OF THE PREFERRED EMBODIMENTS

The present invention is of a system and method which can be used to detect changes in an environment. Specifically, the present invention can be used to detect presence and motion of an object in an environment that includes a known background static or dynamic image.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Detecting the position and movement of an object such as a human in an environment such as an indoor or an outdoor space is typically effected by various silhouetting techniques. Such techniques are typically utilized to determine presence and motion of an individual within the environment for the purpose of tracking and studying athletic movement, for simulation, to enhance analysis for medical purposes, for physical therapy and rehabilitation, security and defense applications, Virtual reality applications, computer games, motion analysis for animation production, robot control through body gestures and the like.

Several silhouetting algorithms are known in the art, see for example “Tracking and Modeling People in Video Sequences” (2001)/Ralf Plankers, Pascal Fua, C. Wren, A. Azarbayejani, T. Darrell, and A. Pentland; and Pfinder: Real-time tracking of the human body. IEEE Transactions on Pattern Analysis and Machine Intelligence, 1997.

Although most silhouetting algorithms are designed to compare foreground and background image information from a captured image of the environment, some utilize preprocessed background image information (generated in the absence of any foreground image information) in order to further enhance detection of object presence or motion [for further detail, please see Joshua Migdal and W. Eric L. Grimson. “Background Subtraction Using Markov Thresholds Computer Science and Artificial Intelligence” Laboratory, MIT; Krueger, M., Gionfriddo, T., Hinrichsen, K.: “VIDEOPLACE—An Artificial Reality” Proceedings of the ACM Conference on Human Factors in Computing Systems (1985); “A System for Video Surveillance and Monitoring” Collins, Lipton, Kanade (1999) Vivid mandala (www.jestertek.com)].

While searching for ways to improve the efficacy of object silhouetting in an environment having a displayed image as a background, the present inventors postulated that object detection can be greatly enhanced if the silhouetting algorithm utilized takes into account information relating to the displayed image.

Thus according to one aspect of the present invention there is provided a system capable of detecting changes (e.g., a change caused by introduction of an object such as a person into the environment) within an environment in which a known image is displayed. The system employs a computing platform which executes a software application configured for comparing at least a portion of an image captured from the environment to a similar or identical portion of the known image.

The phrase “environment in which a known image is displayed” refers to any environment (outdoor or indoor) of any size which includes a known image projected on a surface or displayed by a display device placed within the environment. An example of such an environment is a room or any other enclosed or partially enclosed space which has an image projected on a wall, floor, window or the like.

The phrase “at least a portion” where utilized herein with respect to an image, refers to one or more pixels of an image or an area of an image represented by one or more pixels.

As is further described hereinbelow and in the Examples section which follows, the algorithm employed by the system of the present invention compares the image captured from the environment to the known image (stored by the system) to efficiently and easily identify and silhouette an object present in the environment. Such comparison can be effected for static background images and for dynamic background image since the system of the present invention is capable of determining what the image displayed (in the absence of an object) is at any given time.

The system of the present invention can be used in a wide range of applications. For example, it can be utilized in medical applications for identifying objects (e.g., cells) in biological samples having a known background image, or for tracking automobile traffic against a background having a known static or dynamic image. Additional applications include interactive digital signage, control rooms, movie production, advanced digital projectors with shadow elimination, collaborative environments, future office solutions, virtual keyboards and the like.

Depending on the application, the system of the present invention can include additional components such as cameras, projectors and the like. The description below provides greater detail on one exemplary application of the system of the present invention.

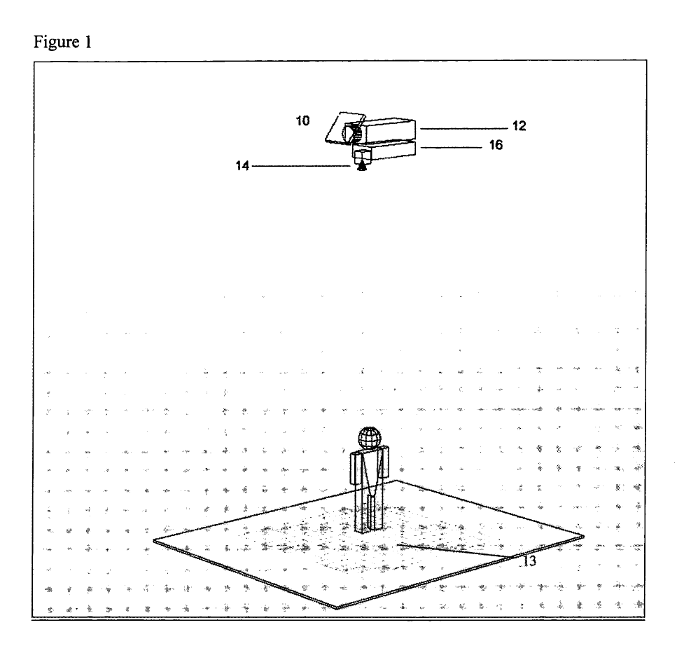

Referring now to the drawings, FIG. 1 illustrates an interactive system for translating a change to an environment into input data, which is referred to herein as system 10.

System 10 includes an image display device 12 (e.g., an LCD display or a projector) which is configured for displaying an image 13 within the environment which can be, for example, a room, a hall or a stadium. Such displaying can be effected by positioning or integrating a display device (LCD, plasma etc.) within the environment (e.g., mounting it on a wall) or by projecting image 13 onto a surface present in the environment (e.g., wall, window, floor etc.). System 10 further includes an image capture device 14 (e.g., a CCD camera) which is configured for capturing image information from the environment. Image capture device 14 is preferably positioned such that it enables capturing of both background image information and any objects (e.g. the person shown in FIG. 1) present in a predefined area adjacent to the background image. For example, in a floor projected image such as the one shown in FIG. 1, image capture device 14 is preferably positioned above the projected image such that it can capture any objects moving next to or directly above the projected image.

In addition to the above, system 10 includes a computing platform 16 which executes a software application configured for comparing at least a portion of an image as displayed by said image display device and a similar or identical portion of the image as captured by the image capture device.

To enable such comparison, computing platform 16 stores information relating to the image displayed by the display device. This enables computing platform 16 to identify (and subtract) background image information in the image captured by the image capture device and as a result to identify foreground image information and silhouette an object present in the environment. Examples 1 and 2 below provide detailed information and flow chart diagrams which illustrate in great detail one algorithm which can be used by computing platform 16 for object identification and tracking. It will be appreciated however, that any silhouetting algorithm which can utilize known background image information can be utilized by the present invention. Silhouetting algorithms are well known in the art. For further description of silhouetting algorithms which can be used by the present invention, please see A. Elgammal, D. Harwood, and L. Davis. Non-parametric model for background subtraction. In European Conference on Computer Vision, 2000; A. Monnet, A. Mittal, N. Paragios, and V. Ramesh. Background modeling and subtraction of dynamic scenes. In IEEE International Conference on Computer Vision, 2003; and Joshua Migdal and W. Eric L. Grimson. Background Subtraction Using Markov Thresholds Computer Science and Artificial Intelligence Laboratory, MIT.

Once silhouetting is achieved, object presence and motion can be utilized as input data which can be used to, for example, change the image displayed by display device 16 or to collect data on object behavior, location, relation to displayed background etc. It should be noted that in cases where object presence and/or motion are utilized to alter the displayed image, computing platform 16 updates the background image stored therein, such that efficient tracking of object motion and presence of new objects can be maintained.

As is mentioned hereinabove, the image displayed by image display device 12 can be a static or a dynamic image. It will be appreciated that since computing platform 16 of system 10 of the present invention stores information relating to the content of the image displayed by image display device 12, it is as efficient in silhouetting objects against a static or a dynamic image background since it can determine at any given time which of the captured image information belongs to the background image.

One approach for differentiating between background and foreground image information is pixel color values. Since the displayed image is displayed by image display device 12 and since the content of the image is known to, or determined by system 10 (for example, image data can be stored by computing platform 16), the color value of each pixel of the known background image can be sampled (and corrected if necessary, see Example 1) and compared to the color value of at least some of the pixels of the captured image to detect color value variations. Such variations can be used to silhouette an object present in the environment. Example 2 of the Examples section below provides further detail of such an approach.

System 10 of the present invention can also include additional output devices such as speakers which can be used, for example, to provide audio information along with the displayed image information.

System 10 represents an Example of an on-site installation. It will be appreciated that a networked system including a plurality of system 10 installations is also envisaged by the present invention.

Such a networked configuration can include a central server which can carry out part or all of the functions of computing platform 16. The central server can be networked (via LAN, WAN, WiFi, WiMax or a cellular network) to each specific site installation (which includes a local computing platform, image display 12 and image capture device 14) and used to control background image display and object silhouetting.

System 10 of the present invention (onsite or networked) can be utilized in a variety of applications, including, for example, interactive games, interactive digital signage, interactive advertising, information browsing applications, collaborative environments, future office solutions, virtual keyboards, and the like.

One specific and presently preferred application is in the field of interactive advertising. Interactive advertising allows people in public locations to interact with advertising content in a seamless and intuitive way. For advertisers it creates a new way for increasing brand awareness, creating emotional reaction that makes public advertising more effective.

Due to its ability in quickly and efficiently identifying foreground objects, system 10 of the present invention is suited for delivering and monitoring interactive advertising information and in particular advertising information which includes rich, dynamic images (e.g., video).

A typical advertising installation of system 10 is described in Example 4 of the Examples section which follows.

Such a system can be used in an overhead installation in a mall and used to project an advertising banner on a floor which can include static or dynamic images optionally accompanied by sound. As people walk over the projected area, the system identifies them, tracks their body movements and alters the banner accordingly (altering the image/video and optionally any accompanying sound). For example, the system projects a static banner with the logo of mineral water brand. As people walk over the banner, the background image is modified in real time to represent a water ripple video effect (with optional accompanying sound effects) around each person that moves over the banner.

The above describes a scenario in which object presence and motion is translated into input commands for system 10. It will be appreciated however, that object presence and motion can also be utilized to collect data on, for example, the effectiveness or exposure of an advertisement. To enable such data collection computing platform 16 of system 10 tracks and also counts foreground objects and in some cases types (gender, age) human objects.

To enable object (e.g. people) counting, computing platform 16 utilizes the silhouetting algorithm described herein to simultaneously track and count a plurality of individuals. This can be accomplished by identifying the border of each silhouette thus differentiating it from other silhouettes. Each silhouette is followed over consecutive frames to keep track of its location and to eliminate multiple counting of the same individual. If a silhouette moves out of the field of view of the image capture device (e.g. camera), the system allows a grace period, during which, reappearance of a silhouette with similar characteristics (e.g., aspect ratio, speed, overall size) will be counted by the system as the same individual; otherwise it will be counted as a new individual. Such multiple object counting enables to collect data on the number of the people who interact with the system over a predetermined time period, the average time spent in front of an advertising campaign, the effectiveness of the system during different hours of the day etc.

The system of the present invention can also detect if movement of an object or a body gesture is related to the content displayed by the image display device. This enables analysis of interactivity between a user of the system and the displayed content. For example, if the system displays an interactive advertising video which includes a ball that reacts to the person movement or body gestures, the system can compare object movements or body gestures with the location of ball in the video to determine the level of interaction between the advertised content and the person viewing it. When statistics relating to the level of interactivity are combined with statistics relating to the time spent by each person in front of an advertisement, an effectiveness measure can be determined for a specific interactive advertising campaign. The system can also be configured to count the number of people that pass within the FOV of the image capture device and yet do not interact with the displayed content. Such individuals can be identified by the system and counted as “passive viewers”; individuals standing within the FOV of the image capture device within a certain radius from the displayed content while the other people (i.e. “active users”) interact with the content are counted by the system as passive viewers. The system could also count the number of people that shift from a state of passive viewers to active (interactive) viewers.

To enable gender or age typing, computing platform 16 utilizes stored statistical information relating to distinguishing features of males, females and young and mature individuals. Such features can be, for example, height (can be determined with respect to background image or camera FOV), hair length, body shape, ratio between height and width and the like.

Such data can be used to alter the image content displayed (either in real time or not), or to collect statistical information which can be provided to the advertiser.

Thus, the present invention provides a system which can be utilized to detect changes in an environment and in particular changes induced by introduction of an object such as a ball or a person into the environment. The system of the present invention is suitable for use in environments that include a static or dynamic image displayed via a display (e.g., LCD, OLED, plasma and the like) or projected via a projector, since image information displayed by such devices can be controlled and the content of such images (e.g., pixel color and position) is predetermined.

It is expected that during the life of this patent many relevant silhouetting algorithms will be developed and the scope of the term silhouetting is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

For the purpose of these Examples the following definitions will be used:

CV—Computer Vision, image processing performed by a computerized device for the purpose of extracting information from a captured image.

CV result—a property, condition or test that a CV algorithm generates.

CV algorithm—an algorithm utilized in a CV process.

Camera Image—Image captured by a still or video camera (typically a digital image); such an image can be processed by a CV algorithm.

Background—a portion of the Camera Image that is considered static.

Foreground—a portion of the Camera image that is not a part of the background.

Silhouette—an image that enables visual separation between foreground and background information, by for example, assigning one color to the foreground image(s) (e.g., white) and another contrasting color (e.g. black) to the background image; a silhouette can be generated by silhouetting algorithms which from a part of CV applications. Typical input for a silhouetting algorithm is a Camera Image which includes background and foreground information. Silhouetting can be utilized to locate an object or person that is part of the foreground by utilizing a reference image of the background. A silhouetting algorithm attempts to detect portions of the Camera image which resemble the known (reference) background image, other portions which do not, are assumed to be part of the foreground.

False positive—Any part of the silhouette that is marked foreground although it should have been considered background. A good algorithm minimizes false positives.

False Negative—Any part of the silhouette that is marked background although it should have been considered foreground. A good algorithm minimizes false negatives.

### Example 1

### Projection Based Background Generation

Silhouetting is utilized by numerous many CV applications for example the “silhouette extraction” demo provided with the EyesWeb CV program (www.eyesweb.org).

Typically a camera is locked on a fixed position having a specific constant background (wall, floor etc.) and foreground image information is separated using a Silhouetting algorithm see the “silhouette extraction” demo provided with EyesWeb). An output image of such processing can then be inspected for activity at a specific location (“Hot Spot”), or used as input for additional CV algorithms such as edge detection, single/multiple object tracking etc. For example the “pushing walls” demo from the EyeWeb package where an algorithm detect the bound around the dancer by processing the silhouette image).

All known silhouette algorithms employ the following steps:

(i) construction of a background (reference) image. This is typically effected by a single frame capture of background image information only. This image can be captured when a particular system is first deployed and no foreground information is present. A background image does not have to be constant; it can be updated periodically to reflect changes in light conditions and changes that occurred in the background. A typically system may store several background images each reflecting a specific time point or lighting condition.

(ii) comparing image information captured from the camera with the known background image to separate foreground information from background information. Such “Background Subtraction” can be performed by any one of several known algorithms, for additional information, please refer to: “Background Subtraction Using Markov Thresholds”—Joshua Migdal and W. Eric L. Grimson, MIT.

Although such Silhouetting algorithms can be utilized to extract foreground information from environments having static backgrounds, in environments characterized by dynamic image backgrounds (e.g. in which a video image is displayed as a background), the background is not static and thus it cannot be utilized as a reference. In the above describe algorithms, dynamic background images increases the likelihood of false positives and false negatives, and thus such algorithms cannot be used for generating Silhouettes in such settings.

An additional limitation of systems employing prior art Silhouetting algorithms is shadowing. In cases where a dynamic background image is generated by a projector (e.g. a projector mounted on a ceiling and projecting onto a floor), objects in the foreground may create shadows thus further increasing the likelihood for false negatives.

To overcome the first limitation, one may set particular zones (region of interest) in which silhouetting is generated thus avoiding constantly changing regions. Such a solution would not detect changes in foreground information against dynamic background image regions.

To overcome both of the above described limitations, one may reduce the sensitivity (threshold) of detection. This solution will reduce the false positives but will increase the false negatives.

The Algorithm of the Present Invention

The present improvement to Silhouetting algorithms was designed with these limitations in mind. The resultant improved algorithm utilized by the present invention can be utilized to obtain information relating to a displayed dynamic image and to predict presence and movement of an object against a dynamic background while dramatically increasing accuracy and efficacy. The present algorithm employs several steps as follows:

(i) initiation sequence; this sequence can be fully automated or effected manually, and may require several calibration steps that utilize calibration images. The initiation sequence is utilized to gather the following data:
Location of the projector in the camera image and its Orientation (Direction). such information is referred to herein as the Screen Projection Coordinates (SPC).
Information as to how the various projector colors are captured by the camera image, such information is utilized to generate a color shift table (CST).

(ii) frame processing. Following an initiation sequence, the projected image is not altered (unless an update procedure is called for, further detailed below). Every set up frame captured by the camera will be processed to extract the background image (frame buffering may be necessary to accomplish this) and to construct a background image by:
Blurring the camera image to reduce camera noise.
Using the Screen Projection Coordinates (SPC) to place an image capture in a correct location and orientation over a new black image (It will stay black for areas that are not projected). Such an image is termed herein as a Dynamic Background Image (DBI); the DBI is blurred to the same extant as the camera image. Once a DBI is created it is stored as an Updated Reference Image (URI).
using the CST, the color of the DBI is adjusted to reflect colors expected to be captured by the camera. This will generate a background image suitable for processing by a silhouetting algorithm.

If shadows are expected, a second a black image (no projection) is generated using the CST (a black image is modified by the CST to simulate a screen without any projection. the SBI can be an integral part of the CST). This provides image information in the absence of projection; by processing small image regions, shadows are simulated. The above can be skipped by designing the CST in the following implementation we have designed the CST to provide the SBI image data at the multidimensional array location CST[0, 0, 0, x, y] where x and y are the coordinates of the relevant SBI. See the data entities section below for complete definitions of the applied terms.

Following shadow prediction, the background image can be used directly in the chosen image subtraction method.

If the SBI is used for shadow forecasting the image is subjected to subtraction twice, once for the DBI and once for the SBI, different subtraction methods can be used and the resulting silhouette is marked true only where there is a change from the DBI and from the SBI (not shadow and not background).

Updating the CST and SPC

Since the mounting point of the camera and the projected zone in the environment are assumed to be constant, dynamic updating of the SPC is not necessary in most cases since it only contains geometric information of the projection plane in the camera image.

A background image however can be effected by numerous factors including: change of surrounding light (day-night, lights turned on/off), dimming of the projector/display due to lamp/screen end of life or new objects that are added to the background (gum on floor, graffiti on wall). All these factors will introduce false positives if not considered.

Updating of the background image can be effected using an active or a passive approach. Active updating is effected by changing the projection (similar to initiation) for several frames in a manner which will enable the camera to capture the altered frame while a human user won't notice any change in display. Once altered frame information is captured by the camera, update of the CST will be effected in a manner similar to that described above for the initiation sequence, only it will be effected in a manner which will enable discounting of any objects present in the foreground (by, for example, processing only portions of the image at different times).

Passive updating is effected by finding the difference between processed DBI and the camera image (can be effected by background subtraction techniques) and generating a difference image (for each pixel reduce the DBI from the camera image). Each pixel of the difference image is then compared to its respective point in the URI and the CST is changed/updated accordingly. Such an approach can be utilized to update the CST to reflect changes since initialization. It should be noted that such recalibration should not be run too frequently (relatively to how much gradual each update is) as it might collect temporary changes in the foreground and regard them as background causing increase in false negatives

An additional improvement to the algorithm that improves the silhouette is described below.

Instead of updating the entire image (or all the planned cells in the CST), independent on whether there is an object on the foreground or not, a problem that increases the false positives, one can plan an algorithm that updates the background image (or CST) per pixel with dependence on two factors: whether the pixel was classified as foreground or background and a timeout for each pixel (can be the “future use” byte in the RGB struct). The algorithm updates the pixel (or cell) on two constrains: if the pixel was marked “background” or the timeout of the cell reached a set threshold (under 256). After updating the pixel (gradually of course) the timeout is set to nil. If the pixel (or cell) wasn't updated, then the timeout byte is increased.

This algorithm cleans the background image (or CST) from the noise that is expected when updating it using the algorithm described hereinabove.

### Example 2

### Algorithms that can be Utilized by the Present Invention

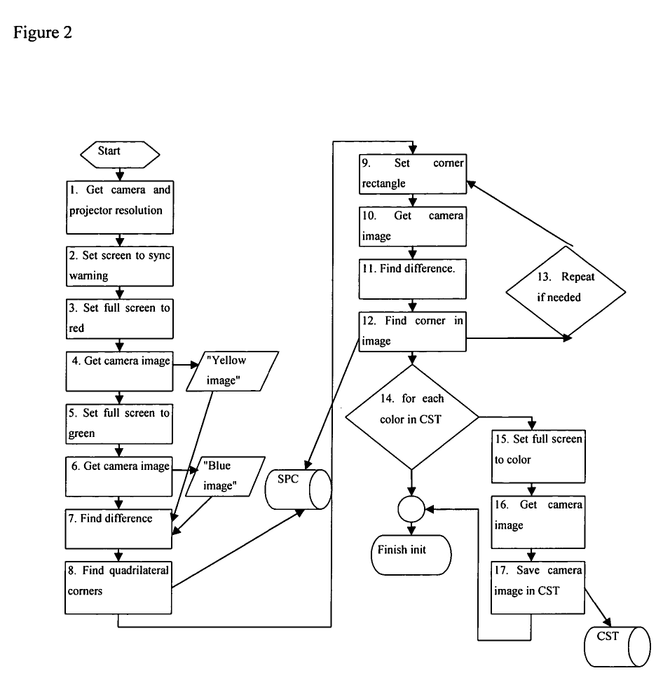

FIG. 2 illustrates a flow chart diagram outlining system calibration in accordance with the teachings of the present invention.
1. The first camera frame will provide the camera resolution, a Windows API can be used to provide the projector resolution.
2. The projector shall display a warning to clear camera capture area for a few seconds, following which the initiation process is initialized.
3. In order to check the maximum projected area the algorithm sets the whole projection area to a set color (e.g. yellow) following which the image from the camera is saved and then a second color (e.g. blue) is processed and saved. The projection screen can then be set to the desired color by creating a full screen application and setting the whole application window to that color.
4. Saving the yellow camera image to an IplImage (a part of OpenCV). Camera updating may require capture of several frames due to lag.
5. Setting the screen to blue.
6. Saving the blue screen. Camera updating may require capture of several frames due to lag.
7. A simple absolute subtraction between each pixel of both images and channel summation will provide a single channel mask image where high values indicate the projected zone.
8. Using a corner detection algorithm to detect the 4 best corners (e.g. the OpenCV function cvGoodFeaturesToTrack further explained below) the four best corners are identified and connected so they do not overlap. Since the mask from step 7 is very clean, the projection corners will be selected.
9. In order to get the orientation of the projection, a blue screen is displayed with a yellow rectangle in one of its corners, by finding the location of the small quadrilateral compared to the one found in step 8 that corner can be tagged.
10. Getting the camera image for the projection orientation.
11. Similar to step 7 but performed on different images.
12. Using a corner detection algorithm to detect the 4 best corners (e.g., the OpenCV function cvGoodFeaturesToTrack) the four best corners are identified and connected so they do not overlap. Since the mask from step 11 is very clean, the quadrilateral that represents the drawn rectangle in step 9 will be selected.
13. Repeat until all cases of symmetry are disqualified (typically not more than three times).
14. since the CST is the camera image expressed as number of colorsˆ3 all colors are iterated according to the CST, and the projector is filled for each color and the camera image is saved in the CST.
15. Set the full screen to the current color of the CST.
16. Get the camera image
17. Save the camera image according to the correct color of the CST.

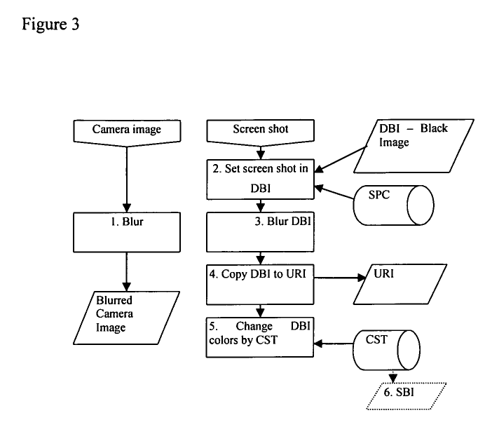

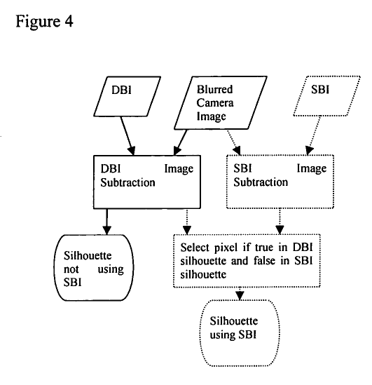

FIG. 3 illustrates a flow chart diagram outlining background image generation in accordance with the teachings of the present invention.
1. The camera image is blurred in order to reduce camera noise.
2. Set the screen shot in the correct location in a new black image (It will stay black for areas that are not projected) according to the SPC; generate DBI.
3. The DBI is blurred to the same extant as the camera image.
4. Save the DBI as an Updated Reference Image (URI).
5. Change the color in the DBI from the screen colors to the colors expected to be seen in the camera using the CST. This generates the background image for the silhouette algorithm.
6. (optional) If shadows are expected, a black (no projection) image is generated according to the CST (the only difference from the DBI is skipping the placement of the screen shot image). This provides an image with no projection. Small regions are processed to simulate shadows. This operation can avoided by planning the CST in a specific manner or at least constructed only when the CST is updated as it is independent on the screenshot or the camera image. (SBI—shadow background image)
   If step 6 above is not employed, the background image is completed and it can be used directly in image subtraction. If step 6 is used (see FIG. 4), image subtraction is employed twice, once for the DBI and once for the SBI, different subtraction methods can be utilized and the resulting silhouette is marked true only where there is a change from the DBI and from the SBI (qualified as not shadow and not background).

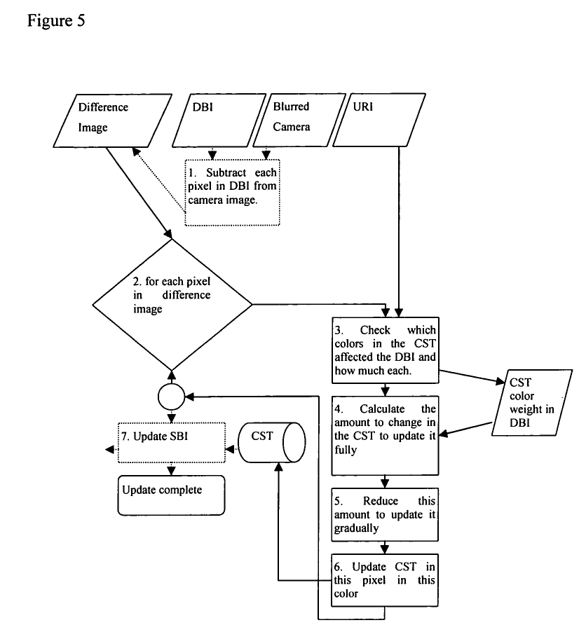

FIG. 5 illustrates a flow chart diagram outlining CST updating in accordance with the teachings of the present invention.
1. A difference image is typically calculated during silhouette creation. In case where it isn't, the update function is utilized to create it by simply reducing each pixel in the DBI to the corresponding pixel in the blurred camera image.
2. For each pixel in the difference image (and the camera image and the DBI and the URI) it is checked what color was calculated in the DBI before the transformation to the camera colors, this value is copied to the URI. Comparison between the value in the URI and the current camera is the base value of the CST, thus this value is inserted gradually so temporary artifacts will have little effect. Since the CST includes only a sample of the colors, the values in the CST that affected the URI are first identified (these can be saved from the background generation phase but it may be more efficient to calculate them from scratch using the algorithm described herein).
3. The value stored in the correct pixel in the URI is obtained and used to calculate which values in the CST were used to create a suitable DBI.
4. The minimal change in the values that affected the DBI are used in order to adjust the camera image.
5. The amount of change found in part 4 is reduced so that the transition of the CST will be gradual and will filter out temporary artifacts.
6. Updates the correct cells in the CST according to the cells found in step 3 and the amount found in step 5.
7. An SBI is calculated in case one is used, it isn't an integral part of the CST and it isn't calculated for every frame.

### Example 3

### Auto Exposure

The following technique is used if the camera is set to auto exposure. It can be useful to set the camera to auto exposure in order to deal with lighting changes that change to a very large degree. The auto exposure introduces new challenges to the silhouetting algorithm since the brightness of the image change constantly and hence the background image (or CST) never represents the current wanted background. This situation increases the amount of false positives.

In order to compensate the auto exposure we can build a system that will calculate the shift of values from the background image to the viewed background in the camera image. This system will check a large sample of pixels in both images (it can be the whole image too, but that will take its toll on performance). Generally, its best to take pixels from the entire image but for specific applications there might be better locations than others in the image to check like a reference point that can never be obscured from the camera. The said algorithm it will compare between the two pixels and create a histogram of the differences. Since the most common color shift in the image in most applications is the change from the background image to the observed background, we can easily find the largest region in a histogram and that region will be our said shift. Compensating for the shift is easy as adding/removing the shift values from the Camera Image.

### Example 4

### System Configuration

The present system can utilize any off the shelf components, a typical system can utilize the following:
1. A computer running Microsoft Windows XP™. The computer can be a Dual Pentium™ 4 3.2 Ghz with 1.5 GB of RAM and 120 GB of Hard Drive although computers with slower processors and less ram can also be used or computers running a different operating system (e.g., Linux, Mac OSX) can also be utilized.
2. A CCD camera connected via USB to the computer. To simplify processing, the auto exposure of the camera shall be disabled (This option can be activated if provided with a compensating algorithm).
3. A LCD/DLP projector/display connected via the RGB connector to the computer.
4. The Intel OpenCV library (open source). A library that contains various common CV algorithms and provides an easy connection to the camera image.
5. Microsoft DirectX 9.0c SDK for direct access to the screen buffer for screenshot extraction.
6. Microsoft VisualStudio.Net for writing and compiling the program using the c and c++ languages. Windows XP™, DirectX, OpenCV and VS.NET should be installed as written in documentation provided with the products.

For floor projection, the projector, computer and camera are mounted on the ceiling, the projector and camera will face the floor directly or will utilize a set of mirrors to project the image on the floor and to capture image information therefrom. The camera will capture the entire image projected on the floor. The floor and any image projected thereupon constitutes the background for processing sake, any object present within the camera field of view (FOV) is the foreground.

The input of the processing algorithm described above is a color image preferably in an IplImage format which is captured by the camera.

The output of the silhouette algorithm is a single channel IplImage in the same resolution as the camera image where black represents areas that are background and white represents areas that are foreground.

The x axis is defined as starting from the left and moving to the right starting from the first pixel (X=0) of the captured image. The y axis is defined as starting from the top and moving to the bottom starting from the first pixel (Y=0) of the captured image.

Data Entities

The SPC is defined by 4 (X, Y) point coordinates of the projection as captured by the camera: 1. upper left, 2. upper right, 3. lower left, 4. lower right. Perspective distortions can be compensated for using known algorithms. An RGB struct (struct is a structure in the c programming language containing variables) is defined as 4 unsigned chars (8 bit numbers): red, green, blue and future use. The CST is defined as a 5-dimensional array of RGB structs. It is defined as [number of reds, number of greens, number of blues, camera X axis resolution, camera Y axis resolution] it is assumed that the number of all colors is the same and is a power of 2 (the camera resolution can be reduced in order to preserve memory at the expense of CPU usage).

The SBI value can be found at CST [0, 0, 0, x, y] for each X, Y value of the camera image since r=0, g=0, b=0 is black and the CST has the same resolution as the camera image.

The DBI is an IplImage of the same color depth as the camera image (3 channels 8 bits each).

The difference image is defined as an array of signed 16 bit integers of a size determined by X axis camera resolution*Y axis camera resolution.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An interactive system for translating a change to an environment into input data, the system comprising:
(a) an image display device configured for displaying an image within the environment;
(b) an image capture device configured for capturing image information from the environment; and
(c) a computing platform executing a software application being configured for:
(i) comparing at least a portion of said image as displayed by said image display device and said at least a portion of said image as captured by said image capture device to thereby determine the change to the environment; and
(ii) translating the change into input data.

2. The system of claim 1, wherein the change within the environment is caused by introduction of an object into the environment.

3. The system of claim 1, wherein said image displayed by said image display device is a static image.

4. The system of claim 1, wherein said image displayed by said image display device is a dynamic image.

5. The system of claim 1, wherein said computing platform stores information regarding said image displayed by said image display device.

6. The system of claim 1, wherein step (i) is effected by comparing pixel color value.

7. The system of claim 6, wherein said computing platform is capable of predicting said pixel color value of said image captured by said image capture device according to the environment.

8. The system of claim 1, wherein said image displayed by said image display device is a static or a dynamic image.

9. The system of claim 8, wherein said image displayed by said image display device is displayed by projection onto a surface present in the environment.

10. The system of claim 8, wherein said image displayed by said image display device is displayed by a monitor present within the environment.

11. The system of claim 8, wherein said computing platform stores information regarding said image displayed by said image display device.

12. The system of claim 1, wherein step (i) is effected by a silhouetting algorithm.

13. The system of claim 2, wherein step (i) discounts shadowing caused by said object.

14. A method of translating a change to an environment having an image displayed therein into input data, the method comprising:
(a) capturing an image of the image displayed within the environment to thereby generate a captured image; and
(b) computationally comparing at least a portion of said captured image to said at least a portion of the image displayed to thereby determine the change to the environment; and
(c) translating the change into input data.

15. The method of claim 14, further comprising computationally correcting said captured image according to at least one physical parameter characterizing the environment prior to step (b).

16. The method of claim 15, wherein said at least one physical parameter is lighting conditions.

17. The method of claim 14, wherein step (b) is effected by comparing a color value of pixels of said at least a portion of said captured image to said color value of said pixels of said at least a portion of the image displayed.

18. The method of claim 14, wherein the image displayed within the environment is a static image.

19. The method of claim 14, wherein the image displayed within the environment is a dynamic image.

20. The method of claim 14, wherein the image displayed within the environment is a projected image.

21. The method of claim 14, wherein the change to the environment is caused by introduction of an object to the environment.

22. The method of claim 21, wherein step (b) is further for characterizing a shape and optionally movement of said object within the environment.

23. The method of claim 14, wherein step (b) is effected by a silhouetting algorithm.

24. The method of claim 21, wherein step (b) discounts shadowing caused by said object.

25. A system capable of detecting changes within an environment in which a known image is displayed, the system comprising a computing platform executing a software application being configured for comparing at least a portion of an image captured from the environment to said at least a portion of the known image to thereby detect changes in the environment.

26. The system of claim 25, wherein the change within the environment is caused by introduction of an object into the environment.

27. The system of claim 25, wherein the known image is a static image.

28. The system of claim 25, wherein the known image is a dynamic image.

29. The system of claim 25, wherein said computing platform stores information regarding the known image.

30. The system of claim 25, wherein said comparing said at least a portion of said image captured from the environment to said at least a portion of the known image is effected by comparing pixel color value.

31. The system of claim 30, wherein said computing platform is capable of predicting said color value of said pixels of said image captured from the environment according to the environment.

32. The system of claim 25, wherein the known image includes a displayed picture or video.

33. The system of claim 32, wherein said displayed picture or video is displayed by projection onto a surface of the environment.

34. The system of claim 32, wherein said displayed picture or video is displayed by a monitor placed within the environment.

35. The system of claim 32, wherein said computing platform stores information regarding said displayed picture or video.
